(19) United States
(12) Patent Application Publication
(10) Pub. No.: US 2025/0392671 A1
(43) Pub. Date: Dec. 25, 2025

(54) STORAGE MEDIUM, INFORMATION PROCESSING APPARATUS, AND CONTROL METHOD THEREFOR

(71) Applicant: CANON KABUSHIKI KAISHA, Tokyo (JP)

(72) Inventor: ANNA HOSAKA, Ibaraki (JP)

(21) Appl. No.: 19/242,657

(22) Filed: Jun. 18, 2025

(30) Foreign Application Priority Data
Jun. 24, 2024 (JP) 2024-101544

(51) Int. Cl. H04N 1/00; G06F 3/12

(52) U.S. Cl. CPC H04N 1/00676; G06F 3/1205; G06F 3/1258

(57) ABSTRACT

A printer driver causes an information processing apparatus capable of communicating with an image forming apparatus having a cutting function of cutting a sheet of paper subjected to printing to perform operations including transmitting print data to the image forming apparatus; accepting a setting for enabling the cutting function; and, upon accepting the setting, displaying, in the information processing apparatus, a line along which the sheet of paper is to be cut by the cutting function on an image that is based on the print data in such a way as to enable a user to identify the line along which the sheet of paper is to be cut by the cutting function.

### BACKGROUND

### Field of the Disclosure

Aspects of the present disclosure generally relate to a storage medium, an information processing apparatus, and a control method therefor.

### Description of the Related Art

Currently, techniques which print, for example, a document or a photograph on a printing medium are in widespread use. When such techniques are used to perform printing, a phenomenon in which, due to print data for, for example, a document or photograph targeted for printing not fitting into a printing medium, part of printing is missing from a print may occur. Since the user who performs printing is not conscious of the designated print data being partially missing, there may be an occasion where usability decreases. To cope with such an occasion, there is a known technique which, in a case where print data targeted for printing does not fit into a printing medium, processes the print data into a form fitting into the printing medium and then performs printing of the processed print data, such as that discussed in Japanese Patent Application Laid-Open No. 2008-262439.

In addition, a printing system, called a cutting printer, which performs printing of an image on a sheet of paper and then performs cutting of the sheet of paper subjected to printing is also in widespread use.

There is a case of cutting a sheet of paper subjected to printing with use of the cutting printer. For example, in a case where the user performs print settings or issues an instruction for cutting with use of a printer driver, if there is not a configuration which enables the user to understand the position of a line based on which to perform cutting, a sheet of paper may be cut at a position thereof which the user does not intend to set as a cutting position.

### SUMMARY

Some aspects of the present disclosure are generally directed to facilitating the user to understand a position of a sheet of paper at which the sheet of paper is cut.

According to an aspect of the present disclosure, a non-transitory computer-readable storage medium stores a printer driver that, when executed by a computer, causes an information processing apparatus capable of communicating with an image forming apparatus having a cutting function of cutting a sheet of paper subjected to printing to perform operations that comprise transmitting print data to the image forming apparatus; accepting a setting for enabling the cutting function; and, upon accepting the setting, displaying, in the information processing apparatus, a line along which the sheet of paper is to be cut by the cutting function on an image that is based on the print data in such a way as to enable a user to identify the line along which the sheet of paper is to be cut by the cutting function.

Further features of various embodiments will become apparent from the following description of exemplary embodiments with reference to the attached drawings.

### BRIEF DESCRIPTION OF THE DRAWINGS

FIG. 1 is a diagram illustrating an example of a hardware configuration of a cutting printer.

FIG. 2 is a block diagram illustrating an example of a configuration of a communication system including the cutting printer.

FIG. 3 is a block diagram illustrating an example of a hardware configuration of a communication terminal.

FIG. 4 is a block diagram illustrating an example of a configuration of a printer driver for the cutting printer, which runs on the communication terminal.

FIG. 5 is a diagram illustrating an example of a setting screen of the printer driver for the cutting printer.

FIG. 6 is a flowchart illustrating an example of processing for suggesting editing of print information for the cutting printer in an exemplary embodiment of the present disclosure.

FIG. 7 is a flowchart illustrating an example of a subprocess which is included in the processing illustrated in the flowchart of FIG. 6 and is performed in the case of editing print information.

FIG. 8A is a diagram illustrating an example of a pop-up window for communicating a warning and a suggestion for editing printing information to the user. FIG. 8B is a diagram illustrating an example of a pop-up window for communicating a warning to the user. FIG. 8C is a diagram illustrating an example of a pop-up window for communicating a suggestion for editing printing information to the user.

FIG. 9 is a diagram illustrating an example of a sequence which is performed for the cutting printer in the exemplary embodiment.

FIG. 10 is a diagram illustrating an example of a sequence which is included in the sequence illustrated in FIG. 9 and is performed in a case where part of printing is missing.

FIG. 11 is a flowchart illustrating an example of processing for issuing a notification for a warning about part of printing being missing in the cutting printer in the exemplary embodiment.

FIG. 12 is a diagram illustrating an example of a sequence for issuing a notification for a warning about part of printing being missing in the cutting printer in the exemplary embodiment.

### DESCRIPTION OF THE EMBODIMENTS

Various exemplary embodiments, features, and aspects of the disclosure will be described in detail below with reference to the drawings. Furthermore, the scope of the present disclosure is not limited to configurations described in the exemplary embodiments. Within a range in which similar advantageous effects are obtainable, various modifications or alterations, such as replacing part of the configuration or part of the processing with an equivalent thereof or omitting such part, can be made.

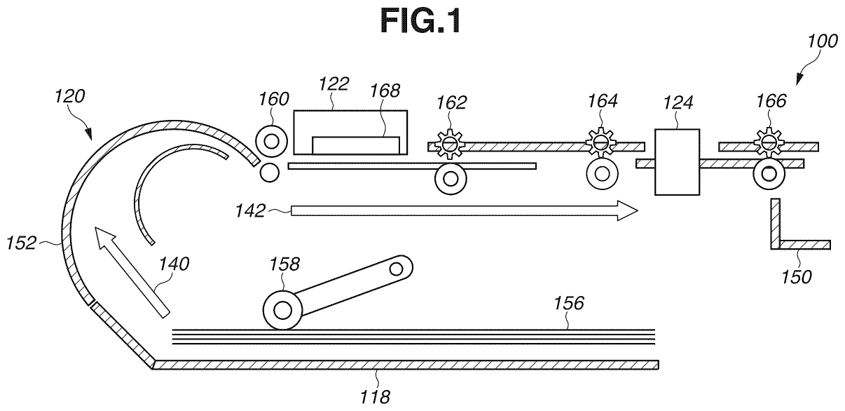

FIG. 1 is a diagram illustrating an example of a hardware configuration of a cutting printer 100 in an exemplary embodiment of the present disclosure.

The cutting printer 100, which is an image forming apparatus or a printing apparatus, includes a containing unit 118, a conveyance unit 120, a print execution unit 122, a cutting unit 124, and a sheet discharge tray 150. The containing unit 118, the conveyance unit 120, the print execution unit 122, and the cutting unit 124 are provided inside a chassis (not illustrated) of the cutting printer 100. The sheet discharge tray 150 is exposed on the outside of the chassis. The containing unit 118 contains cut sheets 156. The term “cut sheet” means, for example, a sheet of paper previously cut into a preliminarily determined size, such as A4 size, A5 size, letter size, or postcard size. The sheet sizes mentioned here are merely examples. In the present exemplary embodiment, cut sheets with any one of A4 size and A5 size are contained in the containing unit 118. Arrow 140 and arrow 142 are arrows representing conveyance directions of a sheet of paper which is conveyed from the containing unit 118 to the sheet discharge tray 150.

The conveyance unit 120 includes a conveyance path 152 and a plurality of rollers 158, 160, 162, 164, and 166. The cut sheets 156, which are contained in the containing unit 118, are conveyed one by one along the conveyance path 152 by, for example, the roller 158. In the present exemplary embodiment, the print execution unit 122 includes an inkjet head 168. The inkjet head 168 ejects ink onto the cut sheet 156 conveyed by the rollers 158 and 160 and thus prints an image on the cut sheet 156. The cut sheet 156 subjected to printing is further conveyed toward the downstream side in the conveyance direction by the rollers 162 and 164. In a modification example, the print execution unit 122 can include a laser-type printing mechanism. The cutting unit 124 includes a cutting blade (not illustrated). The cutting unit 124 cuts the cut sheet 156 subjected to printing by the cutting blade moving in a direction perpendicular to the plane of the drawing sheet of FIG. 1. This causes the cut sheet 156 to be divided into a portion on the upstream side in the conveyance direction and a portion on the downstream side in the conveyance direction. Particularly, the cutting unit 124 performs cutting along a straight line interconnecting the respective middle positions of a pair of long sides of the cut sheet 156, thus cutting the cut sheet 156 in half. The cutting unit 124 is able to cut, for example, an A4-size cut sheet in half, thus forming two A5-size disconnected sheets of paper. Each disconnected cut sheet 156 is further conveyed toward the downstream side in the conveyance direction by the roller 166. This causes each disconnected cut sheet 156 to arrive at the sheet discharge tray 150. In this way, the cutting printer 100 in the present exemplary embodiment is able to cut the cut sheet 156. Therefore, as long as preparing, for example, A4-size cut sheets, the user of the cutting printer 100 is able to obtain sheets of paper subjected to printing having a size (for example, A5 size) smaller than A4 size. For example, a situation in which, when the user wants to perform printing on A5-size cut sheets, the user does not have A5-size cut sheets in possession is conceivable. In that case, the cutting printer 100 is able to perform printing on an A4-size cut sheet and then perform cutting (disconnection) of the sheet of paper subjected printing by executing the cutting function, thus providing A5-size cut sheets to the user.

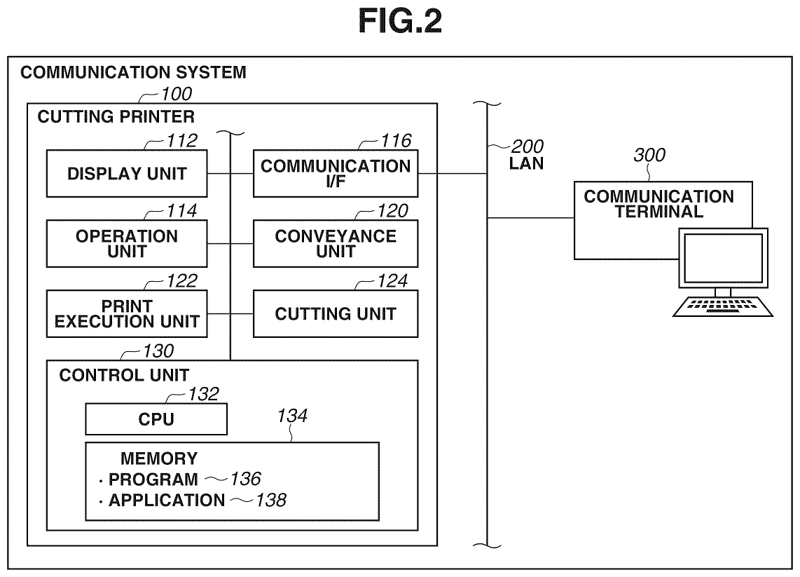

Next, a configuration of a communication system including a cutting printer is described with reference to FIG. 2. The communication system includes a communication terminal 300 and a cutting printer 100. Another terminal can be separately included in the communication system. The cutting printer 100 and the communication terminal 300 are connected to a local area network (LAN) 200 and are able to communicate with each other via the LAN 200. The LAN 200 can be a wired LAN or can be a wireless LAN.

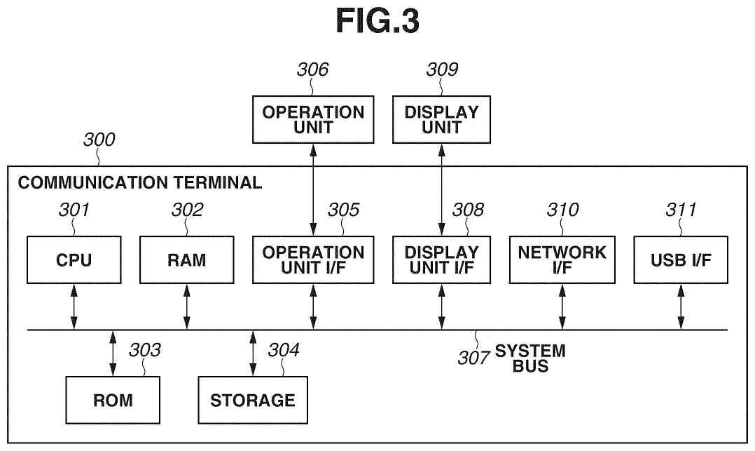

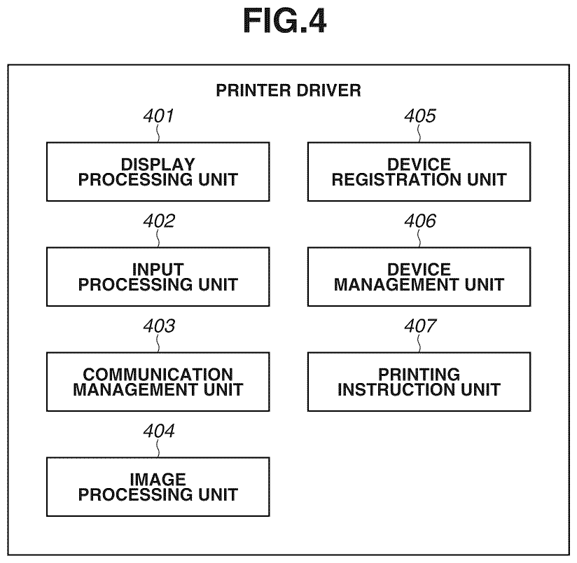

The communication terminal 300, which is an information processing apparatus, is a portable terminal device such as a smartphone, a tablet personal computer (PC), or a personal digital assistant (PDA), and is able to communicate with the cutting printer 100. In a modification example, the communication terminal 300 can be a stationary terminal device. A hardware configuration and software configuration of the communication terminal 300 are illustrated in FIG. 3 and FIG. 4, respectively.

The cutting printer 100 is a peripheral device (for example, a peripheral device for the communication terminal 300) capable of executing a printing function. The cutting printer 100 includes a display unit 112, an operation unit 114, a communication interface (I/F) 116, a print execution unit 122, a cutting unit 124, and a control unit 130. The units 112 to 130 are connected to a bus line (reference character omitted). Because of including the cutting unit 124, the cutting printer 100 is a printer capable of performing cutting of cut sheets.

The display unit 112 is a display for displaying various pieces of information. The display unit 112 is a touch panel, and also functions as an operation unit which is able to be operated by the user. The operation unit 114 is an interface for performing acceptance of inputting of various instructions issued from the user.

The user is able to input various instructions to the cutting printer 100 via the operation unit 114. The communication I/F 116 is connected to the LAN 200.

The control unit 130 includes a central processing unit (CPU) 132 and a memory 134. The CPU 132 performs various processing operations according to a program 136 stored in the memory 134. The memory 134 is configured with, for example, a volatile memory or a non-volatile memory. The memory 134 stores an operating system (OS) program 136 and an application 138. In the following description, the OS program 136 and the application 138 are referred to as an “OS 136” and an “app 138”, respectively. The OS 136 is a program for controlling basic operations of the cutting printer 100. The app 138 is a program for causing the cutting printer 100 to perform printing. For example, the app 138 is installed by a vendor of the OS 136 on the cutting printer 100 from a server (not illustrated) placed on the Internet.

FIG. 3 is a diagram illustrating a configuration of the communication terminal 300. A CPU 301 reads out control programs stored in a read-only memory (ROM) 303 or a storage 304 and thus performs control of functions of the communication terminal 300. A random access memory (RAM) 302 is a main memory for the CPU 301 and is used as a temporary storage region for loading thereon various control programs stored in the ROM 303 or the storage 304. The ROM 303 stores control programs, which are executable by the CPU 301. The storage 304 is a storage device, such as a solid state drive (SSD) or a hard disk drive (HDD), and stores image data or application programs. An operation unit I/F 305 interconnects an operation unit 306 and the communication terminal 300.

The operation unit 306 is a device for detecting an input received from the user, and is assumed to include a mouse and a keyboard. A display unit I/F 308 interconnects a display unit 309 and the communication terminal 300. The display unit 309 is a device for displaying processing details in the communication terminal 300 in such a way as to enable the user to understand those, and is assumed to be a liquid crystal monitor. A network I/F 310 performs transmission and reception of data to and from an external device via a network. For example, the network I/F 310 is able to transmit print data generated by a printer driver to the cutting printer 100. A Universal Serial Bus (USB) I/F 311 performs transmission and reception of data to and from an external device via a cable of the USB standard. Furthermore, the USB I/F 311 is also able to transmit the print data to the cutting printer 100. The operation unit 306 can be connected to the communication terminal 300 via the USB I/F 311. A system bus 307 relays exchange of data between the respective units.

FIG. 4 is a diagram illustrating a configuration of a printer driver, which is stored in the storage 304 of the communication terminal 300 and performs cooperation with the cutting printer 100. A display processing unit 401 controls a content to be displayed on the display unit 309 at the time of application execution. An input processing unit 402 detects an input received from the operation unit 306 at the time of application execution, and transmits data to another functional unit. A communication management unit 403 controls communications with the cutting printer 100 via the network I/F 310. An image processing unit 404 performs generation of print data from image data based on a user operation input from the input processing unit 402. A device registration unit 405 detects image forming apparatuses (devices), including, for example, the cutting printer 100, which are connected to the communication terminal 300 via the network I/F 310 or the USB I/F 311, and stores information about each detected device in the storage 304. The information about each device includes the type of each device and communication information about each device. A device management unit 406 performs updating or deletion on information about each device registered by the device registration unit 405. A printing instruction unit 407 transmits print data to the cutting printer 100 or an image forming apparatus based on a user operation input from the input processing unit 402. In performing transmission, the printing instruction unit 407 uses communication information about the device which is currently managed by the device management unit 406.

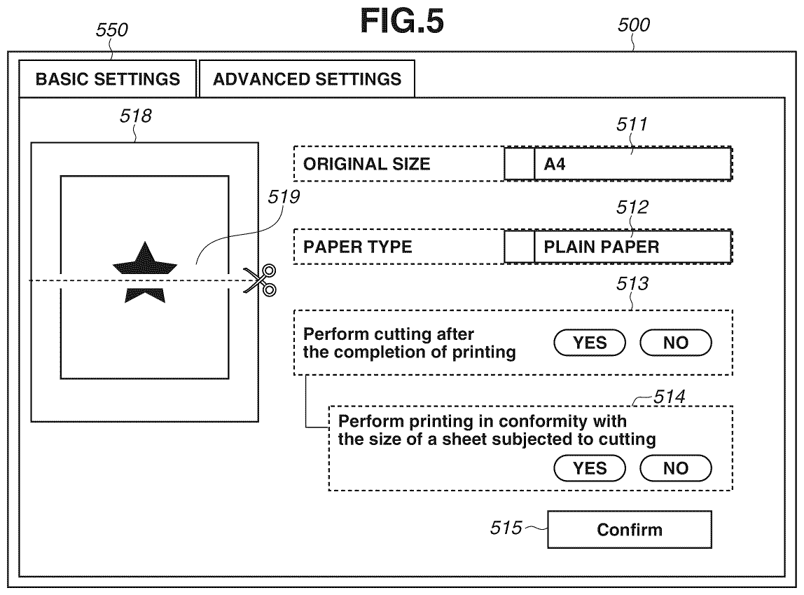

Furthermore, the printer driver is also able to cause a preview display application, which is installed together at the time of installation of the printer driver, to display a preview image that is based on print data generated by the image processing unit 404. In that case, the preview image which the preview display application displays is similar to a preview image 518 (FIG. 5) which the display processing unit 401 displays, but is displayed in a window (screen) different from a print setting screen 500 (FIG. 5) in which the preview image 518 is displayed.

FIG. 5 is a diagram illustrating an example of a print setting screen 500 which is displayed on the display unit 309 by the printer driver for the cutting printer 100, which runs on the communication terminal 300 illustrated in FIG. 2. The print setting screen 500 is a software module which is implemented by the CPU 301 executing a main program loaded on the RAM 302, and includes a plurality of types of print setting screens depending on types of image forming apparatuses besides the cutting printer 100. Screen displaying of the print setting screen 500 can differ depending on the types. The user downloads the printer driver onto the RAM 302 via, for example, a web page, a USB memory, or a disc. On this occasion, the method of downloading can be any method. The user starts up the communication terminal 300, launches the printer driver in a state in which image data targeted for printing is being displayed by, for example, an editing application, and performs print settings in the print setting screen 500. In the following description, display items of the print setting screen 500 are described.

A drop-down list 511 is a drop-down list for selecting an original size (the size of an original). Here, the drop-down list 511 is used to designate the size of a medium on which to print a print target. Examples of sizes which can be designated include A4 and B5. Information about the sheet size selected in the drop-down list 511 is included in print data to be transmitted to the cutting printer 100. Upon receiving the print data, the cutting printer 100 determines from which sheet feeding unit to convey a sheet of paper, based on information about the paper size and paper type included in the print data. While, in the example illustrated in FIG. 5, A4 is currently selected, the size to be selected may be another size.

A drop-down list 512 is a drop-down list for selecting a sheet type. Here, the drop-down list 512 is used to select the type of sheets of paper to be contained in the containing unit 118 of the cutting printer 100. Examples of sheet types which can be designated include plain paper and heavy paper. While, in the example illustrated in FIG. 5, plain paper is currently selected in the drop-down list 512, the paper type can be optionally selected from among sheet types with which the cutting printer 100 is compatible.

A button 513 is a button for selecting whether to cut a printed product after the completion of printing.

Specifically, accepting the selection of “YES” in the button 513 means accepting the setting of enabling the cutting function. If “YES” is selected in the button 513, a button 514 and a button 515 each described below become selectable. Furthermore, in a case where an image forming apparatus associated with the printer driver does not have a cutting capability, the button 513 is grayed out, thus becoming impossible to select. The presence or absence of the cutting capability can be determined by any one of the following two methods. With regard to the first method, in a case where the printer driver is a printer driver dedicated to the cutting printer 100, a capability response of the cutting printer 100 is included in the setting information obtained at the time of installation of the printer driver. Therefore, the printer driver is able to determine the presence or absence of the cutting capability. On the other hand, with regard to the second method, in a case where the printer driver is a universal printer driver, the printer driver acquires a capability response when associating the printer driver and the cutting printer 100 with each other, thus determining the presence or absence of the cutting capability. Moreover, in the button 513, either “YES” or “OR” is exclusively selected.

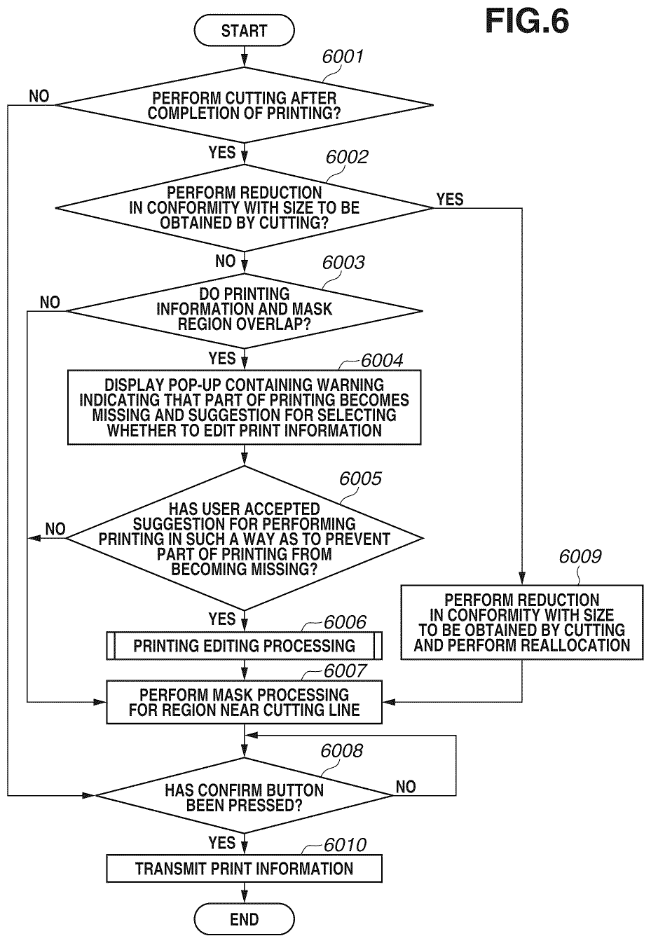

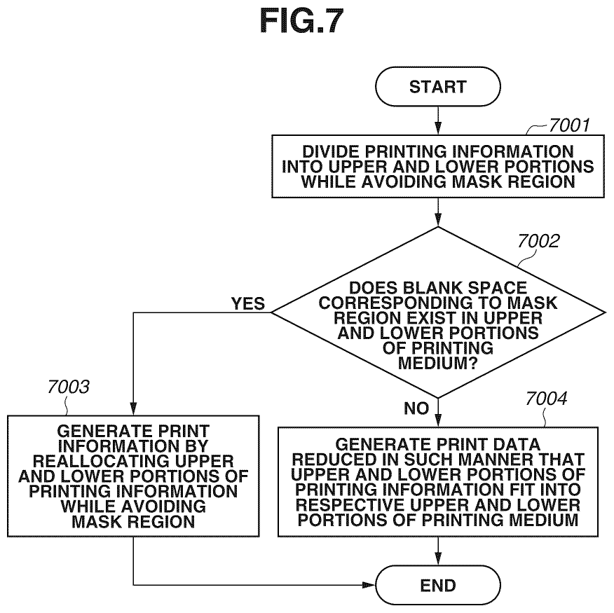

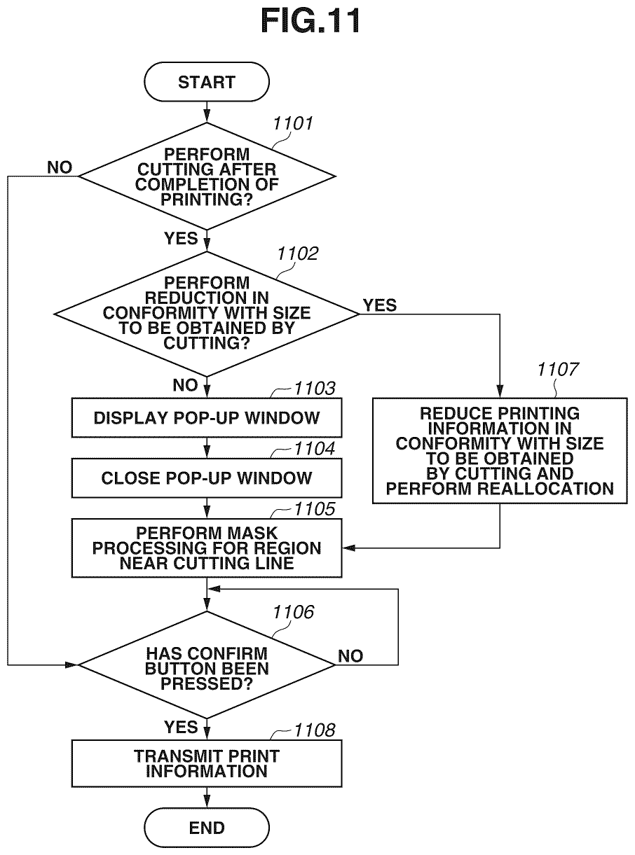

A button 514 is a button for, in a case where print information corresponds to, for example, one side of A4 size, selecting whether to reduce (scale) the print information to A5 size and then printing the reduced print information on upper and lower portions of a printing medium. If “YES” has been selected, in a case where a print target has been one side of A4 size, the cutting printer 100 divides a printing medium in conformity with a cutting line, allocates respective print targets each for one side of A4 size to regions obtained by division, and performs printing under such condition. Thus, if “YES” in the button 514 is selected, a first setting in which the cutting printer 100 prints, on a sheet of paper, an image for one page and an image for another one page and then cuts, by the cutting function, the sheet of paper in half in such a manner that the image for one page and the image for another one page are separated from each other is made. If “NO” is selected, a second setting in which the cutting printer 100 prints an image for one page on a sheet of paper and then cuts, by the cutting function, the sheet of paper in half in such a manner that the image for one page is divided into two images is made. Moreover, if “NO” is selected, the printer driver performs processing illustrated in the flowcharts of FIG. 6, FIG. 7, and FIG. 11 described below, and, as a result of the processing, displays a pop-up screen or edits print information. Moreover, in the button 514, either “YES” or “OR” is exclusively selected.

If a confirm button 515 is selected, print data including setting information that is based on the contents set in the print setting screen 500 is transmitted from the network I/F 310 to the cutting printer 100 via the LAN 200. The CPU 132 of the cutting printer 100 receives the print data via the communication I/F 116. The CPU 132 executes a main program loaded onto the memory 134 based on the set contents. In a case where “YES” is previously selected in the button 513, the CPU 132 performs processing for performing cutting after the completion of printing.

A preview image 518 is a print preview display. In the preview image 518, an image which is to be printed in conformity with the size of a printing medium is displayed. While, in the example illustrated in FIG. 5, a star mark is displayed in the preview image 518, the display content is optional. Print data which the user has designated can be displayed in the preview image 518.

A cutting line and mask region for cutting line 519 is an image display representing a cutting line, which is to be used for an original size (the size of an original), and a mask region, in which printing is inhibited. Here, the cutting line and mask region for cutting line 519 expresses that printing in an approximately middle portion of a sheet of paper becomes missing.

In this way, a cutting line is displayed on an image that is based on print data in such a way as to enable the user to identify a line along which the sheet of paper is to be cut by the cutting function. Moreover, as mentioned above, the preview image 518 and the cutting line and mask region for cutting line 519 can be configured to be displayed not by the printer driver but by the preview display application. In that case, the printer driver issues an instruction to the preview display application to display the preview image 518 and the cutting line and mask region for cutting line 519. Thus, in response to “YES” in the button 513 having been selected, the printer driver causes, via the preview display application, the display unit 309 of the communication terminal 300 to display a cutting line on an image that is based on print data.

A basic setting tab 550 is a tab for performing settings related to printing and cutting. The basic setting tab 550 can include a plurality of tabs. In response to the tabs being switched, item displays which are settable are similarly switched.

FIG. 6 is a flowchart illustrating an example of processing for suggesting editing of print information for the cutting printer 100 in the present exemplary embodiment.

In step 6001, the user selects, via the button 513, whether to cut a printed product after the completion of printing in the print setting screen 500 executed on the communication terminal 300. If the user has selected “YES” in the button 513 (YES in step 6001), the grayed-out state of the button 514 is cancelled, so that the button 514 becomes selectable, and the printer driver advances the processing to step 6002. If the user has selected “NO” in the button 513 (NO in step 6001), the printer driver advances the processing to step 6008.

In step 6002, the user selects, in the print setting screen 500, whether to reduce (scale) printing in conformity with the size of a printed product to be obtained by cutting. For example, in a case where the user has selected A4 size in the drop-down list 511 and the printed product has been cut, two sheets of paper of A5 size are discharged. Therefore, in a case where the user has selected “YES” in the button 514, print data of A4 size is reduced to A5 size for 2-in-1 printing, the obtained print data of A5 size is printed on a sheet of paper, and, then, the sheet of paper is subjected to cutting processing. If the user has selected “YES” in the button 514 (YES in step 6002), the printer driver advances the processing to step 6009. If the user has selected “NO” in the button 514 (NO in step 6002), the printer driver advances the processing to step 6003.

In step 6003, the printer driver analyzes print information which the user has designated, and the printer driver compares the analyzed print information with coordinate information about a mask region near a cutting line, which the printer driver is retaining as a setting value.

The method of acquiring a mask region which is performed by the printer driver is as follows. In a case where the printer driver is the one dedicated to the cutting printer 100, the printer driver is retaining coordinate information about a mask region within the setting information obtained at the point of time when the user installed the printer driver on the communication terminal 300.

On the other hand, in a case where the printer driver is a universal printer driver, the printer driver acquires a capability response of the cutting printer 100 when the user associates the cutting printer 100 with the printer driver. The printer driver acquires coordinate information about a mask region from the retained capability response.

If the printing information and the mask region overlap (YES in step 6003), the printer driver advances the processing to step 6004, and, if the printing information and the mask region do not overlap (NO in step 6003), the printer driver advances the processing to step 6007. The cutting printer 100 performs cutting processing immediately after the completion of printing and, therefore, performs masking in such a way as to prevent printing from being performed on a region near the cutting line. Therefore, in a case where the user has put print data, for example, at a middle portion of a sheet of paper, printing of a portion, in the print data, which overlaps a mask region near the cutting line may become missing.

Here, there are cases where printing information is bit-mapped information or page-description language (PDL) information. In a case where printing information is bit-mapped information, coordinates and colors included in the printing information are stored in print data. Therefore, the printer driver compares coordinates of a mask region near the cutting line retained in the printer driver with coordinates of printing information retained in the bit-mapped information, thus determining whether printing information and a mask region overlap.

In a case where printing information is PDL information, information obtained by combining, for example, characters, graphics, and images is stored in print data on a page-by-page basis. Therefore, the printer driver compares coordinates of a mask region near the cutting line retained in the printer driver with coordinates of objects retained in the PDL information, thus determining whether printing information and a mask region overlap.

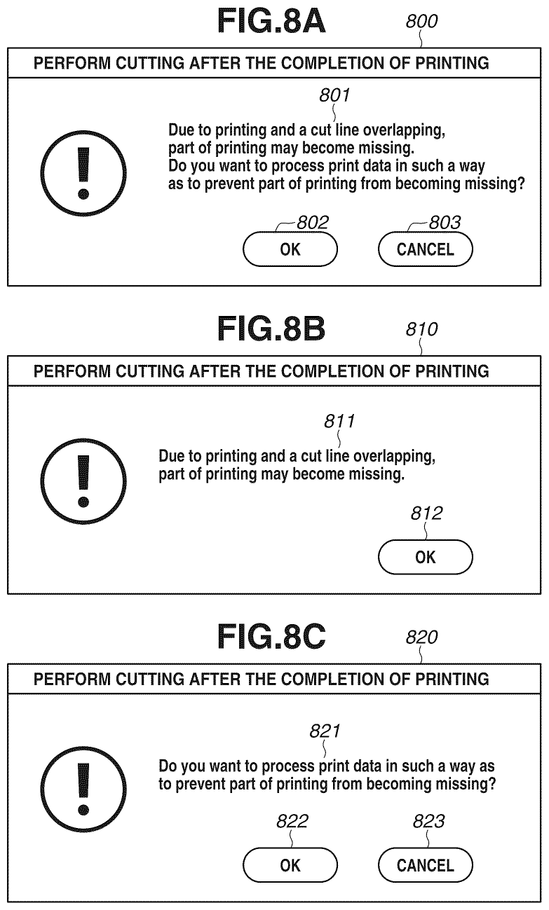

In step 6004, the printer driver issues a warning indicating that, due to a mask region overlapping a printing region, part of printing may become missing. Moreover, at the same time, the printer driver presents a suggestion as to whether to print data subjected to processing for preventing part of printing from becoming missing. Therefore, the printer driver displays a pop-up window containing a warning message and a suggestion message, as illustrated in FIG. 8A. However, the warning message and the suggestion message can be displayed in respective separate pop-up windows as illustrated FIG. 8B and FIG. 8C, or can be displayed in the print setting screen 500.

In step 6005, the printer driver determines whether the user has accepted the suggestion about whether to print data subjected to processing for preventing part of printing from becoming missing. The user performs inputting to the operation unit 306, and the operation unit I/F 305 performs analysis of a user input. The operation unit I/F 305 issues a notification of a result of analysis of the user input to the input processing unit 402. The input processing unit 402 receives the notification and performs analysis of the received notification. If, in the analytical result, it is determined that the user has accepted the suggestion (YES in step 6005), the printer driver advances the processing to step 6006. If it is determined that the user has declined the suggestion (NO in step 6005), the printer driver advances the processing to step 6007.

In step 6006, the printer driver performs processing for the printing information in such a way as to prevent part of printing from becoming missing. The processing details thereof are described below with reference to FIG. 7. Upon the completion of the processing, the printer driver advances the processing to step 6007.

In step 6007, the printer driver performs processing for masking a region near the cutting line included in the printing information. The printer driver can acquire positional information by using positional information about a mask region retained in the printer driver or inquiring of the cutting printer 100. Also, the printer driver can be configured to preliminarily retain the setting values of the cutting printer 100. The printer driver performs processing for substituting printing information about a portion corresponding to positional information about the mask region with a blank, and then advances the processing to step 6008.

In step 6008, the printer driver waits for the confirm button 515 to be pressed. The input processing unit 402 of the printer driver determines whether the user input is the confirm button 515, and, if pressing of the confirm button 515 has been detected (YES in step 6008), the printer driver advances the processing to step 6010.

In step 6009, the printer driver analyzes the print information and reduces printing information in conformity with the size of a sheet of paper to be obtained by cutting. The printer driver reallocates the reduced printing information in conformity with the size of a sheet of paper to be obtained by cutting, and then advances the processing to step 6007.

In step 6010, the printer driver refers to the device management unit 406, and acquires communication destination information associated as the cutting printer 100. Then, the printing instruction unit 407 notifies the communication management unit 403 of a printing instruction, the acquired communication destination information, and the print information. The communication management unit 403 transmits the notified information to the communication I/F 116 of the cutting printer 100 via the network I/F 310 and the LAN 200.

FIG. 7 is a flowchart illustrating an example of a subprocess which is included in step 6006 illustrated in the flowchart of FIG. 6 and is performed to process printing information in such a way as to prevent part of printing from becoming missing. All of the processing operations in the flowchart of FIG. 7 are performed by the printer driver.

In step 7001, the printer driver performs processing for dividing printing information into upper and lower portions with respect to a given specific position such as the middle portion of a mask region, and then advances the processing to step 7002. In the following description, for explanation's sake, an upper portion of the printing information is referred to as “printing information A”, and a lower portion of the printing information is referred to as “printing information B”.

Here, as mentioned above with regard to step 6003 illustrated in FIG. 6, there are cases where printing information is bit-mapped information or page-description language (PDL) information.

In a case where printing information is bit-mapped information, coordinates and colors included in the printing information are stored in print data. Therefore, the printer driver compares coordinates of printing information retained in the bit-mapped information with coordinates about the cutting line retained in the printer driver, and thus generates pieces of print data obtained by division into upper and lower portions based on the cutting line.

In a case where printing information is PDL information, information obtained by combining, for example, characters, graphics, and images is stored in print data on a page-by-page basis. Therefore, the printer driver compares coordinates of the cutting line retained in the printer driver with coordinates of objects retained in the PDL information, and thus generates pieces of print data obtained by division into upper and lower portions based on the cutting line.

In step 7002, the printer driver compares a printing medium and printing information with each other based on the print information which the user has set, and determines whether a blank space the size of which is half the size of a mask region exists in each of upper and lower portions of a printing medium. If it is determined that the blank space exists (YES in step 7002), the printer driver advances the processing to step 7003, and, if it is determined that the blank space does not exist (NO in step 7002), the printer driver advances the processing to step 7004.

In a case where print data which the user has input is bit-mapped information, coordinates and colors included in the printing information are stored in print data. Therefore, the printer driver compares coordinates included in the printing information retained in the bit-mapped information with coordinates of an original size (the size of an original) selected in the drop-down list 511 retained in the printer driver, and determines whether a blank space the size of which is half the size of a mask region corresponding to the cutting line exists in each of upper and lower portions of the original size.

In a case where printing information is PDL information, information obtained by combining, for example, characters, graphics, and images is stored in print data on a page-by-page basis. Therefore, the printer driver compares coordinates of the original size retained in the printer driver with coordinates of objects retained in the PDL information, and the printer driver determines whether a blank space the size of which is half the size of a mask region corresponding to the cutting line exists in each of upper and lower portions of the original size.

In step 7003, the printer driver reallocates the printing information A and the printing information B within a printing medium while avoiding the mask region, thus performing generation of print information.

In step 7004, the printer driver performs reduction processing for the printing information in such a manner that, in a case where the printing information A and the printing information B are allocated with the mask region being avoided, the printing information A and the printing information B fit into the respective upper and lower portions of a printing medium. The printer driver reallocates the printing information A and the printing information B subjected to the reduction processing within a printing medium, thus performing generation of print information. After that, the printer driver advances the processing to step 6007 illustrated in the flowchart of FIG. 6.

FIG. 8A illustrates an example of a pop-up window which is displayed in step 6004 illustrated in the flowchart of FIG. 6. The pop-up window is displayed by the display processing unit 401 on the display unit 309 via the display unit I/F 308. Upon detecting a user input, the operation unit 306 communicates the user input to the input processing unit 402 via the operation unit I/F 305. In this way, the printer driver causes the communication terminal 300 to display a message indicating that, in a case where a cutting line and a printing region specified by print data overlap, an image is printed with part of the image being missing. Moreover, the printer driver also causes the communication terminal 300 to display a message for checking whether to perform processing in such a way as to prevent part of the image from becoming missing.

In step 6004 in the flowchart of FIG. 6, the printer driver displays a pop-up window 800. The pop-up window 800 includes messages 801 including a warning message and a suggestion message for suggesting processing print data in such a way as to prevent part of printing from becoming missing. Moreover, the pop-up window 800 further includes an OK button 802 and a cancel button 803. After displaying of the pop-up window 800, the printer driver advances the processing to step 6005, thus waiting for a user input. If, in step 6005, the printer driver has detected that the OK button 802 has been pressed, the printer driver deletes displaying of the pop-up window 800, and then advances the processing to step 6006. If, in step 6005, the printer driver has detected that the cancel button 803 has been pressed, the printer driver deletes displaying of the pop-up window 800, and then advances the processing to step 6007. Moreover, the messages 801 are merely an example, and can be a message different in wording or expression.

FIG. 8B illustrates an example of a pop-up window which is displayed in step 6004 illustrated in the flowchart of FIG. 6. The pop-up window is displayed by the display processing unit 401 on the display unit 309 via the display unit I/F 308. Upon detecting a user input, the operation unit 306 communicates the user input to the input processing unit 402 via the operation unit I/F 305.

In step 6004 in the flowchart of FIG. 6, the printer driver displays a pop-up window 810. The pop-up window 810 includes a warning message 811. The warning message 811 is merely an example, and can be a message different in wording or expression. Moreover, the pop-up window 810 can also include a message for prompting the user to create print data in which part of printing of the print data does not become missing. Then, an OK button 812 can be included in the pop-up window 810. After displaying of the pop-up window 810, the printer driver advances the processing to step 6005, thus waiting for a user input. If, in step 6005, the printer driver has detected that the OK button 812 has been pressed, the printer driver deletes displaying of the pop-up window 810, and then advances the processing to step 6006. In a case where the OK button 812 is not included in the pop-up window 810, after displaying of the pop-up window 810, when a predetermined time has elapsed, the display processing unit 401 can, without waiting for a user input, perform processing for hiding the pop-up window 810. In that case, the printer driver advances the processing to step 6007.

FIG. 8C illustrates an example of a pop-up window which is displayed in step 6004 illustrated in the flowchart of FIG. 6. The pop-up window is displayed by the display processing unit 401 on the display unit 309 via the display unit I/F 308. Upon detecting a user input, the operation unit 306 communicates the user input to the input processing unit 402 via the operation unit I/F 305.

In step 6004 in the flowchart of FIG. 6, the printer driver displays a pop-up window 820. The pop-up window 820 includes a message 821 for suggesting processing print data in such a way as to prevent part of printing from becoming missing. Moreover, the pop-up window 820 further includes an OK button 822 and a cancel button 823. After displaying of the pop-up window 820, the printer driver advances the processing to step 6005, thus waiting for a user input. If, in step 6005, the printer driver has detected that the OK button 822 has been pressed, the printer driver deletes displaying of the pop-up window 820, and then advances the processing to step 6006. If, in step 6005, the printer driver has detected that the cancel button 823 has been pressed, the printer driver deletes displaying of the pop-up window 820, and then advances the processing to step 6007. Moreover, the message 821 is merely an example, and can be a message different in wording or expression.

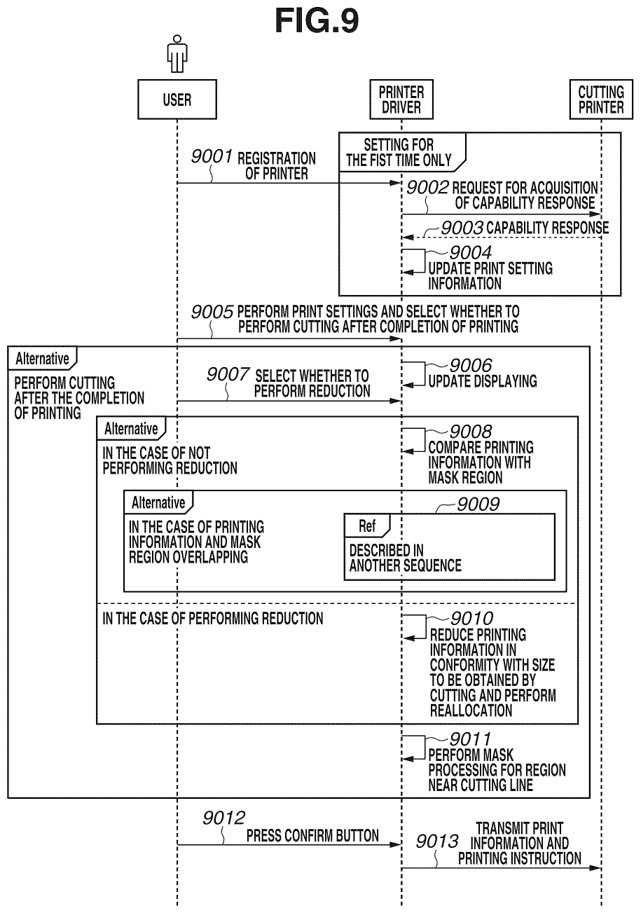

FIG. 9 is a diagram illustrating an example of a sequence which is performed when the cutting printer 100 is used in the present exemplary embodiment.

In step 9001 to step 9004, for the first time only, processing for registering the cutting printer 100 with the printer driver is performed. With regard to display processing related to the printer driver, the display processing unit 401 performs screen configuration processing, issues a drawing instruction to the display unit I/F 308, and causes the display unit 309 to perform displaying. Moreover, the user input processing is implemented by, in response to the operation unit 306 detecting a user input, the operation unit I/F 305 performing notification to the input processing unit 402.

In step 9001, the user executes the printer driver on the communication terminal 300, and registers a printer device which executes a print job with the printer driver.

In step 9002, the printer driver accepts a user input, executes the input processing unit 402, and transmits a notification to the device registration unit 405. The device registration unit 405 receives the notification, and the device registration unit 405 issues an instruction for screen drawing to the display processing unit 401. The user inputs, according to the screen displaying, pieces of information such as an Internet Protocol (IP) address for uniquely defining a printer device to be registered and USB connection destination information. The device registration unit 405 makes an acquisition request for a capability response of the target cutting printer 100 to the communication management unit 403.

In step 9003, the cutting printer 100 transmits the capability response as a reply. The capability response includes pieces of information such as compatible paper sizes, compatible paper types, and information indicating whether the cutting printer 100 is compatible with the cutting function.

In step 9004, the device registration unit 405 receives a notification about the capability response of the cutting printer 100, and the device registration unit 405 notifies the device management unit 406 of data indicating such notification. The device management unit 406 receives a notification of the data, and the device management unit 406 writes management information into the RAM 302. The management information includes, for example, an IP address for uniquely defining a printer, a port name, and a type and device name of a compatible printer driver.

In step 9005, the user calls up the print setting screen 500 such as that illustrated in FIG. 5 with respect to a printing medium which the user wants to use for printing, and performs print settings for, for example, an original size (the size of an original) and a paper type (the type of a sheet of paper). The original size and the paper type are able to be set in the drop-down lists 511 and 512, respectively. In such elements, the result of reception of the capability response in step 9004 is reflected. Moreover, in the button 513, the user selects whether to perform cutting after the completion of printing. If the user has selected “YES” in the button 513, the printer driver advances the processing to step 9006. If the user has selected “NO” in the button 513, the printer driver advances the processing to step 9012.

In step 9006, the printer driver transmits a notification to the display processing unit 401 to display the button 514.

In step 9007, the user selects, via the button 514, whether to perform reduction in conformity with the size of a sheet of paper to be obtained by cutting. If the user has selected “YES” in the button 514, the printer driver advances the processing to step 9010. If the user has selected “NO” in the button 514, the printer driver advances the processing to step 9008.

In step 9008, the printer driver compares printing information included in the print settings with a mask region corresponding to the cutting line retained by the device management unit 406. If the printing information overlaps the mask region, the printer driver advances the processing to step 9009. If the printing information does not overlap the mask region, the printer driver advances the processing to step 9011.

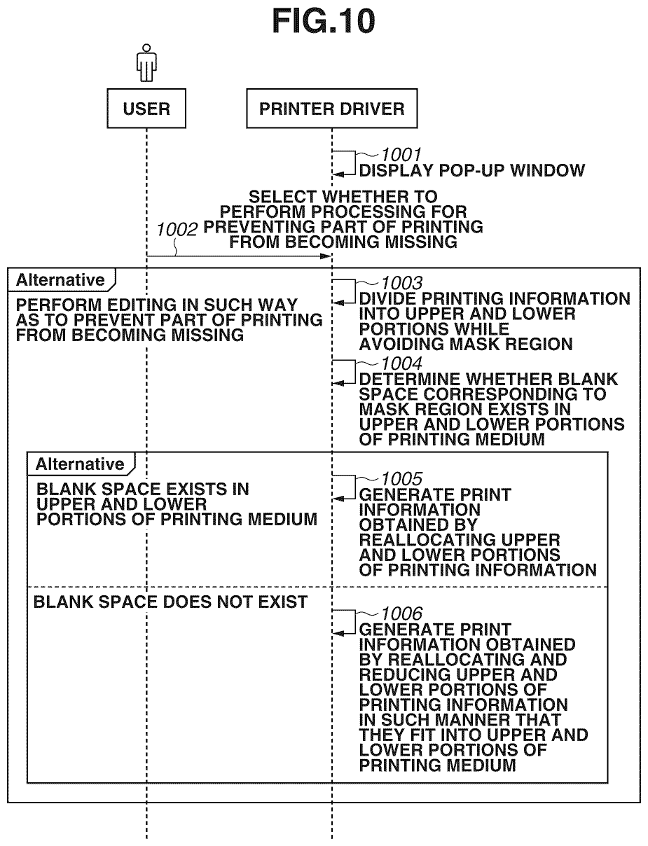

In step 9009, the printer driver edits the printing information in such a manner that the printing information does not overlap the mask region. The detailed sequence in step 9009 is described below with reference to FIG. 10.

In step 9010, in the case of performing reduction in conformity with the size of a sheet of paper to be obtained by cutting, the printer driver edits the printing information in such a manner that the printing information becomes adapted into 2-in-1 printing.

In step 9011, the printer driver performs mask processing on the printing information based on coordinate information about the mask region corresponding to the cutting line retained by the device management unit 406, and thus generates print data.

In step 9012, the user completes the print settings and then presses the confirm button 515. Upon detecting that the confirm button 515 has been pressed, the printer driver advances the processing to step 9013.

In step 9013, the printer driver transmits a printing instruction, together with the print data generated in step 9011, to the registered cutting printer 100 via the printing instruction unit 407.

FIG. 10 is a diagram illustrating an example of a sequence which is performed in step 9009.

In step 1001, the printer driver instructs the display processing unit 401 to display a pop-up window such as that illustrated in FIG. 8A, 8B, or 8C. The sequence illustrated in FIG. 10 is described with use of a pop-up window illustrated in FIG. 8A as an example.

In step 1002, the user selects the OK button 802 or the cancel button 803 displayed in the pop-up window 800. If the user has selected the OK button 802, the printer driver advances the processing to step 1003. If the user has selected the cancel button 803, the printer driver advances the processing to step 9011 in the sequence illustrated in FIG. 9.

In step 1003, the printer driver performs processing for dividing the printing information into upper and lower portions with respect to a given specific position such as the middle portion of the mask region. In the following description, for explanation's sake, an upper portion of the printing information is referred to as “printing information A”, and a lower portion of the printing information is referred to as “printing information B”.

In step 1004, the printer driver compares the printing medium and the printing information with each other based on the print information set by the user, and the printer driver determines whether a blank space corresponding to the mask region exists in each of upper and lower portions of the printing medium. If the result of determination is true, the printer driver advances the processing to step 1005, and, if the result of determination is false, the printer driver advances the processing to step 1006.

In step 1005, the printer driver reallocates the printing information A and the printing information B with respect to blank spaces determined in step 1004.

The printer driver generates print information in which the printing information A and the printing information B fit into the printing medium and are reallocated in such a manner that printing is not applied to the mask region. After that, the printer driver advances the processing to step 9011 in the sequence illustrated in FIG. 9.

In step 1006, the printer driver performs reduction processing for the printing information in such a manner that, in a case where the printing information A and the printing information B are allocated with the mask region being avoided, the printing information A and the printing information B fit into the respective upper and lower portions of the printing medium. The printer driver reallocates the printing information A and the printing information B subjected to the reduction processing within the printing medium, and thus performs generation of print information. After that, the printer driver advances the processing to step 9011 in the sequence illustrated in FIG. 9.

FIG. 11 is a flowchart illustrating an example of processing for issuing a notification for a warning about part of printing being missing in the cutting printer 100 in the present exemplary embodiment.

In step 1101, the user selects, via the button 513, whether to cut a printed product after the completion of printing in the print setting screen 500, which is executed on the communication terminal 300. If the user has selected “YES” in the button 513 (YES in step 1101), the grayed-out state of the button 514 is cancelled, so that the button 514 becomes selectable, and the printer driver advances the processing to step 1102. If the user has selected “NO” in the button 513 (NO in step 1101), the printer driver advances the processing to step 1106.

In step 1102, the user selects, in the print setting screen 500, whether to reduce (scale) printing in conformity with the size of a printed product to be obtained by cutting. For example, in a case where the user has selected A4 size in the drop-down list 511 and the printed product has been cut, two sheets of paper of A5 size are discharged. Therefore, in a case where the user has selected “YES” in the button 514, print data of A4 size is reduced to A5 size for 2-in-1 printing, the obtained print data of A5 size is printed on a sheet of paper, and, then, the sheet of paper is subjected to cutting processing. If the user has selected “YES” in the button 514 (YES in step 1102), the printer driver advances the processing to step 1107. If the user has selected “NO” in the button 514 (NO in step 1102), the printer driver advances the processing to step 1103.

In step 1107, the printer driver analyzes the print information and reduces printing information in conformity with the size of a sheet of paper to be obtained by cutting. The printer driver reallocates the reduced printing information in conformity with the size of a sheet of paper to be obtained by cutting, and then advances the processing to step 1105.

In step 1103, the printer driver issues a warning indicating that, due to a mask region overlapping a printing region, part of printing may become missing. Therefore, the printer driver displays a pop-up window containing a warning message, as illustrated in FIG. 8B.

In step 1104, the printer driver waits for an input from the user. When the printer driver has detected that the OK button 812 displayed in the pop-up window 810 has been pressed, the display processing unit 401 closes the pop-up window 810.

In step 1105, the printer driver performs processing for masking a region near the cutting line included in the printing information. The printer driver can acquire positional information by using positional information about a mask region retained in the printer driver or inquiring of the cutting printer 100. The printer driver performs processing for substituting printing information about a portion corresponding to positional information about the mask region with a blank, and then advances the processing to step 1106.

In step 1106, the printer driver waits for the confirm button 515 to be pressed. The input processing unit 402 of the printer driver determines whether the user input is the confirm button 515, and, if pressing of the confirm button 515 has been detected (YES in step 1106), the printer driver advances the processing to step 1108.

In step 1108, the printer driver refers to the device management unit 406, and the printer driver acquires communication destination information associated as the cutting printer 100. Then, the printing instruction unit 407 notifies the communication management unit 403 of a printing instruction, the acquired communication destination information, and the print information. The communication management unit 403 transmits the notified pieces of information to the communication I/F 116 of the cutting printer 100 via the network I/F 310 and the LAN 200.

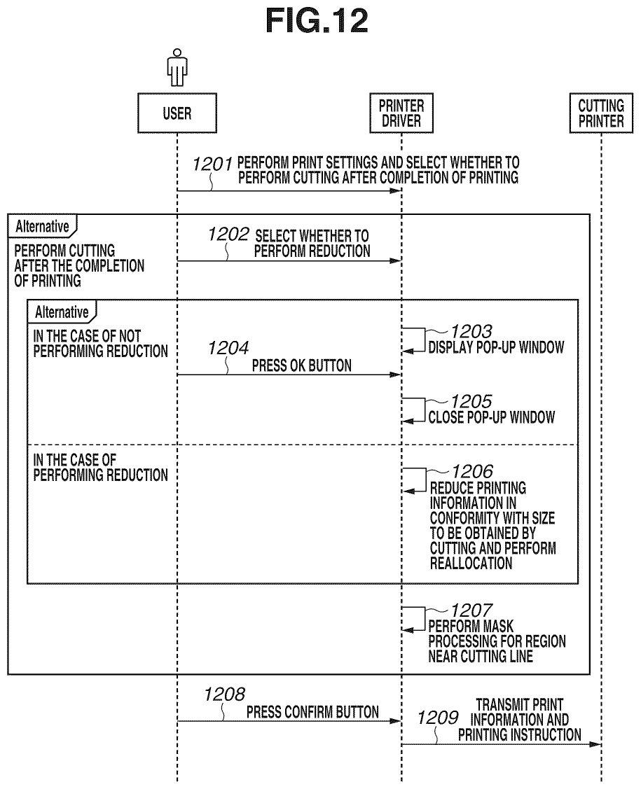

FIG. 12 is a diagram illustrating an example of a sequence for issuing a notification for a warning about part of printing being missing in the cutting printer 100 in the present exemplary embodiment.

In the present sequence, the device registration setting, which is performed for the first time only in step 9001 to step 9004 illustrated in the flowchart of FIG. 9, is omitted from description here.

In step 1201, the user calls up the print setting screen 500 such as that illustrated in FIG. 5 with respect to a printing medium which the user wants to use for printing, and performs print settings for, for example, an original size (the size of an original) and a paper type (the type of a sheet of paper). Moreover, in the button 513, the user selects whether to perform cutting after the completion of printing. If the user has selected “YES” in the button 513, the printer driver advances the processing to step 1202. If the user has selected “NO” in the button 513, the printer driver advances the processing to step 1208.

In step 1202, the printer driver issues a notification to cause the display processing unit 401 to display the button 514. The user checks displaying of the button 514 and performs selection. If the user has selected “YES” in the button 514, the printer driver advances the processing to step 1206. If the user has selected “NO” in the button 514, the printer driver advances the processing to step 1203.

In step 1203, the printer driver displays the pop-up window 810 such as that illustrated in FIG. 8B.

In step 1204, the user checks the pop-up window 810 and presses the OK button 812.

In step 1205, the printer driver receives a notification of the user input, and closes the pop-up window 810.

In step 1206, in the case of performing reduction in conformity with the size of a sheet of paper to be obtained by cutting, the printer driver edits the printing information in such a manner that the printing information becomes adapted into 2-in-1 printing.

In step 1207, the printer driver performs mask processing on the printing information based on the mask region information corresponding to the cutting line retained by the device management unit 406, and thus generates print data.

In step 1208, the user completes the print settings and then presses the confirm button 515. Upon detecting that the confirm button 515 has been pressed, the printer driver advances the processing to step 1209.

In step 1209, the printer driver transmits the print data to the registered cutting printer 100 via the printing instruction unit 407.

### Other Embodiments

Embodiment(s) of the present disclosure can also be realized by a computer of a system or apparatus that reads out and executes computer=executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-101544, which was filed on Jun. 24, 2024 and which is hereby incorporated by reference herein in its entirety.

What is claimed is:

1. A non-transitory computer-readable storage medium storing a printer driver that, when executed by a computer, causes an information processing apparatus capable of communicating with an image forming apparatus having a cutting function of cutting a sheet of paper subjected to printing to perform operations comprising:
transmitting print data to the image forming apparatus;
accepting a setting for enabling the cutting function; and
upon accepting the setting, displaying, in the information processing apparatus, a line along which the sheet of paper is to be cut by the cutting function on an image that is based on the print data in such a way as to enable a user to identify the line along which the sheet of paper is to be cut by the cutting function.

2. The non-transitory computer-readable storage medium according to claim 1, wherein the operations further comprise, upon accepting the setting, displaying, in the information processing apparatus, the line on the image that is based on the print data via a display application.

3. The non-transitory computer-readable storage medium according to claim 1, wherein the operations further comprise, upon accepting the setting, making a first setting or a second setting selectable.

4. The non-transitory computer-readable storage medium according to claim 3,
wherein the cutting function is a function of cutting the sheet of paper subjected to printing in half, and
wherein the first setting is a setting in which the image forming apparatus prints an image for one page and an image for another one page on a sheet of paper and the image forming apparatus cuts, by the cutting function, the sheet of paper in half in such way as to separate the image for one page and the image for another one page from each other.

5. The non-transitory computer-readable storage medium according to claim 4, wherein the second setting is a setting in which the image forming apparatus prints an image for one page on a sheet of paper and the image forming apparatus cuts, by the cutting function, the sheet of paper in half in such a manner that the image for one page separates into two parts.

6. The non-transitory computer-readable storage medium according to claim 1, wherein the operations further comprise, in a case where the line and a printing region specified by the print data are overlapping, displaying, in the information processing apparatus, a message indicating that printing is performed with part of an image being missing.

7. The non-transitory computer-readable storage medium according to claim 1, wherein the operations further comprise, in a case where the line and a printing region specified by the print data are overlapping, displaying, in the information processing apparatus, a message indicating that printing is performed with part of an image being missing and a message for checking whether to perform processing on the print data in such a way as to prevent part of an image from becoming missing.

8. The non-transitory computer-readable storage medium according to claim 1, wherein the operations further comprise accepting a setting of a size of a sheet of paper on which to print the image.

9. An information processing apparatus capable of communicating with an image forming apparatus having a cutting function of cutting a sheet of paper subjected to printing, the information processing apparatus comprising:
at least one memory storing instructions; and
at least one processor that is configured to execute the instructions, wherein execution of the stored instructions causes the at least one processor to:
transmit print data to the image forming apparatus;
accept a setting for enabling the cutting function; and
upon accepting the setting, display a line along which the sheet of paper is to be cut by the cutting function on an image that is based on the print data in such a way as to enable a user to identify the line along which the sheet of paper is to be cut by the cutting function.

10. The information processing apparatus according to claim 9, wherein execution of the stored instructions further causes the at least one processor to, upon accepting the setting, display the line on the image that is based on the print data via a display application.

11. The information processing apparatus according to claim 9, wherein execution of the stored instructions further causes the at least one processor to, upon accepting the setting, make a first setting or a second setting selectable.

12. The information processing apparatus according to claim 11,
wherein the cutting function is a function of cutting the sheet of paper subjected to printing in half, and
wherein the first setting is a setting in which the image forming apparatus prints an image for one page and an image for another one page on a sheet of paper and the image forming apparatus cuts, by the cutting function, the sheet of paper in half in such way as to separate the image for one page and the image for another one page from each other.

13. The information processing apparatus according to claim 12, wherein the second setting is a setting in which the image forming apparatus prints an image for one page on a sheet of paper and the image forming apparatus cuts, by the cutting function, the sheet of paper in half in such a manner that the image for one page separates into two parts.

14. The information processing apparatus according to claim 9, wherein execution of the stored instructions further causes the at least one processor to, in a case where the line and a printing region specified by the print data are overlapping, display a message indicating that printing is performed with part of an image being missing.

15. The information processing apparatus according to claim 9, wherein execution of the stored instructions further causes the at least one processor to, in a case where the line and a printing region specified by the print data are overlapping, display a message indicating that printing is performed with part of an image being missing and a message for checking whether to perform processing on the print data in such a way as to prevent part of an image from becoming missing.

16. The information processing apparatus according to claim 9, wherein execution of the stored instructions further causes the at least one processor to accept a setting of a size of a sheet of paper on which to print the image.

17. A control method for an information processing apparatus capable of communicating with an image forming apparatus having a cutting function of cutting a sheet of paper subjected to printing, the control method comprising:
transmitting print data to the image forming apparatus;
accepting a setting for enabling the cutting function; and
upon accepting the setting, displaying, in the information processing apparatus, a line along which the sheet of paper is to be cut by the cutting function on an image that is based on the print data in such a way as to enable a user to identify the line along which the sheet of paper is to be cut by the cutting function.
